(19) United States
(12) Patent Application Publication
(10) Pub. No.: US 2024/0240067 A1
(43) Pub. Date: Jul. 18, 2024

(54) THERMALLY CONDUCTIVE ADHESIVE COMPOSITION, PREPARATION METHOD AND USE THEREOF

(71) Applicant: Henkel AG & Co. KGaA, Duesseldorf (DE)

(72) Inventors: Wei Yao, Shanghai (CN); Qili Wu, Shanghai (CN); Chenyu Huang, Shanghai (CN); Yuanyuan Yu, Shanghai (CN); Yang Ti, Shanghai (CN)

(21) Appl. No.: 18/615,836

(22) Filed: Mar. 25, 2024

Related U.S. Application Data
(63) Continuation of application No. PCT/CN2021/120104, filed on Sep. 24, 2021.

(51) Int. Cl. C09J 163/00; C09J 11/04; C09J 11/06

(52) U.S. Cl. CPC C09J 163/00; C09J 11/04; C09J 11/06

(57) ABSTRACT

Provided is a thermally conductive adhesive composition, comprising: a) from 0.5 to 30%, preferably from 2 to 20% by weight of an epoxy resin, b) from 0.5 to 30%, preferably from 2 to 20% by weight of an anhydride, c) from 0.1 to 5%, preferably from 0.5 to 3.5% by weight of a catalyst, and d) from 50 to 98%, preferably from 60 to 95% by weight of a metal filler, based on the total weight of the thermally conductive adhesive composition, wherein the catalyst has a core-shell structure with a shell encapsulating a core, the core of the catalyst comprises an amine-based compound, and the shell of the catalyst is prepared by reacting at least two of an epoxy resin, an amine-based compound, and a polyisocyanate. Also provided are a preparation method and use of the thermally conductive adhesive composition.

### TECHNICAL FIELD

The present invention relates to a thermally conductive adhesive composition, a preparation method and use thereof.

### BACKGROUND ART

Nowadays, electronic components, such as semiconductors, are designed with increasingly high densities and high integrations. Heat dissipation is therefore an important and challenging issue for electronic assemblies. For conventional adhesives used to bond electronic elements, a high loading of conductive filler (e.g., Ag) is needed so as to realize a high thermal conductivity. However, use of a large amount of expensive conductive filler will increase production cost of the adhesives.

There is an ongoing demand of a thermally conductive adhesive composition which could realize a high thermal conductivity with a small amount of conductive filler.

### SUMMARY OF THE INVENTION

In order to solve the aforementioned problem, the present inventors provide a thermally conductive adhesive composition, comprising:
a) from 0.5 to 30%, preferably from 2 to 20% by weight of an epoxy resin,
b) from 0.5 to 30%, preferably from 2 to 20% by weight of an anhydride,
c) from 0.1 to 5%, preferably from 0.5 to 3.5% by weight of a catalyst, and
d) from 50 to 98%, preferably from 60 to 95% by weight of a metal filler,
   based on the total weight of the thermally conductive adhesive composition,
wherein the catalyst has a core-shell structure with a shell encapsulating a core, the core of the catalyst comprises an amine-based compound, and the shell of the catalyst is prepared by reacting at least two of an epoxy resin, an amine-based compound, and a polyisocyanate.

The present invention also provides a method for preparing the thermally conductive adhesive composition according to the present invention by mixing all components together.

The present invention further provides a use of the thermally conductive adhesive composition according to the present invention in electronic devices, preferably in semiconductors and diodes, more preferably for die attach.

The present inventors found that by combining the specific components in the specific contents, the resin in the thermally conductive adhesive composition agglomerates and drives the metal fillers to become denser upon curing, therefore, the thermally conductive adhesive composition according to the present invention achieves an excellent thermal conductivity with a small amount of conductive filler. In addition, the cured adhesive composition according to the present invention exhibits good toughness which facilitates stress relief.

### BRIEF DESCRIPTION OF DRAWINGS

The accompanying drawings illustrate embodiments of the present invention and explain principles and mechanisms of the present invention together with the description, but should not be construed as being limitative to the present invention.

FIG. 1a is an SEM image of a cured thermally conductive adhesive composition according to an Example of the present invention.

FIG. 1b, not drawn to scale, schematically illustrates the SEM image of FIG. 1a.

FIG. 2 is an optical microscope image of an uncured thermally conductive adhesive composition corresponding to FIG. 1a.

FIG. 3 is an optical microscope image of a cured thermally conductive adhesive composition corresponding to FIG. 1a.

FIG. 4 is an optical microscope image of a cured thermally conductive adhesive composition according to a Comparative Example.

Reference will now be made in detail to aspects of the present invention, examples of which are illustrated in the accompanying drawing.

### DETAILED EMBODIMENTS OF THE INVENTION

In the present context, the terms “thermally conductive adhesive composition” and “adhesive composition” are exchangeable with each other.

The present invention provides a thermally conductive adhesive composition, upon intensive study, comprising:
a) from 0.5 to 30%, preferably from 2 to 20% by weight of an epoxy resin,
b) from 0.5 to 30%, preferably from 2 to 20% by weight of an anhydride,
c) from 0.1 to 5%, preferably from 0.5 to 3.5% by weight of a catalyst, and
d) from 50 to 98%, preferably from 60 to 95% by weight of a metal filler,
   based on the total weight of the thermally conductive adhesive composition,
wherein the catalyst has a core-shell structure with a shell encapsulating a core, the core of the catalyst comprises an amine-based compound, and the shell of the catalyst is prepared by reacting at least two of an epoxy resin, an amine-based compound, and a polyisocyanate.

The present inventors found that by combining the specific components in the specific contents, the thermally conductive adhesive composition according to the present invention achieves an excellent thermal conductivity with a small amount of conductive filler. In addition, the cured adhesive composition according to the present invention exhibits good toughness which facilitates stress relief.

### Component a) Epoxy Resin

According to the present disclosure, the thermally conductive adhesive composition comprises from 0.5 to 30%, preferably from 2 to 20%, and more preferably from 2 to 15% by weight of component a) an epoxy resin, based on the total weight of the thermally conductive adhesive composition.

The epoxy resin is curable due to the presence of reactive epoxy group(s). Upon curing, the epoxy resin reacts with component b) an anhydride to form crosslinked thermoset plastics with three-dimensional network, and imparts excellent adhesion and heat resistance to the adhesive composition.

With the content of component a) the epoxy resin falling within the above ranges, the thermally conductive adhesive composition achieves an excellent balance among resin agglomeration, thermal conductivity and electrical conductivity.

In some examples of the present disclosure, there is more than one epoxy group, preferably about two or more epoxy groups per molecule of the epoxy resin.

There is no specific limitation on the species of epoxy resins, any epoxy resin commonly used in adhesive compositions may be used in the present disclosure. In some examples, the epoxy resin is selected from the group consisting of polyglycidyl ethers of polyphenols, polyglycidyl ethers of aliphatic polyols, polyglycidyl esters of aliphatic polycarboxylic acids, polyglycidyl esters of aromatic polycarboxylic acids, their derivatives and any combination thereof. Preferably, the epoxy resin is select from polyglycidyl ethers of polyphenols and their hydrogenated derivatives. More preferably, the epoxy resin is selected from the group consisting of biphenol A type epoxy resins, biphenol F type epoxy resins, biphenol S type epoxy resins, hydrogenated biphenol A type epoxy resins, hydrogenated biphenol F type epoxy resins, hydrogenated biphenol S type epoxy resins, novolak type epoxy compounds, and any combination thereof.

Examples of commercially available epoxy resins include, but are not limited to, bisphenol A type epoxy resins such as jER 828US, Epikote 828EL and Epikote 1004 (all manufactured by Japan Epoxy Resin Co., Ltd.); bisphenol F type epoxy resins such as Epikote 806 and Epikote 4004 (all manufactured by Japan Epoxy Resin Co., Ltd.); bisphenol S type epoxy resins such as Epiclon EXA1514 (manufactured by Dainippon Ink and Chemicals Inc.); phenol novolak type epoxy resins such as Epiclon N-770 (manufactured by Dainippon Ink and Chemicals Inc.); orthocresol novolak type epoxy resins such as Epiclon N-670-EXP-S(manufactured by Dainippon Ink and Chemicals Inc.); dicyclopentadiene novolak type epoxy resins such as Epiclon HP7200 (manufactured by Dainippon Ink and Chemicals Inc.) and XD-1000-L (manufactured by Nippon Kayaku Co., Ltd.); biphenyl novolak type epoxy resins such as NC-3000P (manufactured by Nippon Kayaku Co., Ltd.); and naphthalene phenol novolak type epoxy resins such as ESN-165S (manufactured by Tohto Kasei Co., Ltd.).

### Component b) Anhydride

According to the present disclosure, the thermally conductive adhesive composition comprises from 0.5 to 30%, preferably from 2 to 20%, and more preferably from 2 to 15% by weight of component b) an anhydride, based on the total weight of the thermally conductive adhesive composition.

Component b) serves as a curing agent, and reacts with component a) the epoxy resin to form crosslinked thermoset plastics with three-dimensional network, and imparts excellent adhesion and heat resistance to the adhesive composition.

With the content of component b) the anhydride falling within the above ranges, the thermally conductive adhesive composition achieves an excellent balance among resin agglomeration, thermal conductivity and electrical conductivity.

The present inventors surprisingly found that when compared with other types curing agents for epoxy resins, such as phenol-based curing agents, and amine-based curing agents (e.g., guanidine-based curing agents), the anhydride-based curing agents impart a significantly higher thermal conductivity to the whole adhesive compositions.

There is no specific limitation on the species of anhydrides, any anhydrides commonly used in adhesive compositions may be used in the present disclosure. In some examples, the anhydride is selected from the group consisting of monofunctional, bifunctional and multifunctional anhydrides. The anhydride may be an aliphatic anhydride, an alicyclic anhydride, an aromatic anhydride, or any combination thereof. The anhydride is preferably selected from the group consisting of nadic anhydride (NA), methylnadic anhydride (MNA), phthalic anhydride (PA), tetrahydrophthalic anhydride (THPA), methyltetrahydrophthalic anhydride (MTHPA), hexachloroendomethylene tetrahydrophthalic anhydride (Chlorentic Anhydride), endomethylenetetrahydrophthalic anhydride, hexahydrophthalic anhydride (HHPA), methylhexahydrophthalic anhydride (MHHPA), norbonene-based anhydrides such as 5-norbonene-2,3-dicarboxylic anhydride, adipic anhydride, trimellitic anhydride, pyromellitic dianhydride, maleic anhydride (MA), succinic anhydride (SA), nonenylsuccinic anhydride, dodecylsuccinic anhydride (DDSA), polyazelaic polyanhydride, polysebacic polyanhydride, and any combination thereof.

Examples of commercially available anhydrides include HHPA, MTHPA and DDSA available from Anhydrides and Chemicals Inc., Newark, N.J.; MHHPA available from BASF; and MA and MNA available from Aldrich.

In some examples, the molar ratio of the epoxy group in component a) the epoxy resin to the anhydride group in component b) the anhydride is from 0.2 to 3, preferably from 0.7 to 1.3. This molar ratio ensures a sufficient crosslinking reaction between component a) the epoxy resin and component b) the anhydride.

### Component c) Catalyst

According to the present disclosure, the thermally conductive adhesive composition comprises 0.1 to 5%, preferably from 0.5 to 3.5% by weight of component c) a catalyst, based on the total weight of the thermally conductive adhesive composition.

Component c) the catalyst (hereinafter also referred to as “core-shell catalyst”) has a core-shell structure with a shell encapsulating a core, and serves as a latent catalyst. The core-shell catalyst is stable during storage at a temperature of about −40° ° C. Upon heating to a temperature of no less than 80° C., the shell of the core-shell catalyst cracks to expose the active amine-based compound in the core, thereby the catalyst is activated and initiates the crosslinking reaction between component a) the epoxy resin and b) the anhydride.

The core of the catalyst comprises an amine-based compound, and the shell of the catalyst is prepared by reacting at least two of an epoxy resin, an amine-based compound, and a polyisocyanate.

In some examples, the core of the catalyst may contain from 0.001 to 3 parts by mass, preferably from 0.01 to 2.5 parts by mass, more preferably from 0.02 to 2 parts by mass, and still more preferably from 0.03 to 1.5 parts by mass of the amine-based compound, based on 100 parts by mass of the core of the catalyst. With the content of the amine-based compound falling within the above ranges, a dense shell can be formed in a controllable manner in the shell formation reaction, so as to ensure a high storage stability and solvent resistance of the core-shell catalyst.

In addition to the amine-based compound, the core of the catalyst may optionally comprise an amine adduct. The amine adduct may be prepared by reacting an amine-based compound and an epoxy resin. In some examples, the molecular weight distribution of the amine adduct is larger than 1 but no more than 7, preferably from 1.01 to 6.5, more preferably from 1.2 to 5, and furthermore preferably from 1.5 to 4. By having the molecular weight distribution of the amine adduct falling withing the above ranges, the thermally conductive adhesive composition has high curability, high storage stability, and superior adhesive strength.

In some examples, the amine adduct may be obtained by reacting, for example, an epoxy resin and an amine-based compound in the presence of a solvent (if necessary) at the temperature of from 50 to 250° C. for 0.1 to 10 hours. The molar ratio of the active hydrogen group in the amine-based compound to the epoxy group in the epoxy resin is preferably 0.5-10:1, more preferably 0.8-5:1, and still more preferably 0.95-4:1, so as to economically obtain the amine adduct with a desirable molecular weight distribution.

The amine-based compound in the core of the catalyst is identical with or different from, preferably identical with the amine-based compound in the shell of the catalyst.

The amine-based compound used for preparing the amine adduct in the core of the catalyst may be identical with or different from, preferably identical with the amine-based compound in the core of the catalyst and/or the amine-based compound used for preparing the shell of the catalyst.

The amine-based compound in the core of the catalyst, the amine-based compound for preparing the amine adduct (if present), and the amine-based compound in the shell of the catalyst are independently selected from the group consisting of primary amines, secondary amines, imidazole and its derivatives, imidazoline and its derivatives, and any combination thereof; preferably selected from imidazole and its derivatives.

There is no specific limitation on the species of amine-based compounds, and those commonly used in adhesive compositions may be used in the present disclosure.

In some examples, primary amine is selected from methylamine, ethylamine, propylamine, butylamine, ethylenediamine, propylenediamine, hexamethylenediamine, diethylenetriamine, triethylenetetramine, ethanolamine, propanolamine, cyclohexylamine, isophoronediamine, aniline, toluidine, diaminodiphenylmethane, diaminodiphenylsulfone, and any combination thereof.

In some examples, secondary amine is selected from dimethylamine, diethylamine, dipropylamine, dibutylamine, dipentylamine, dihexylamine, dimethanolamine, diethanolamine, dipropanolamine, dicyclohexylamine, piperidine, piperidone, diphenylamine, phenylmethylamine, phenylethylamine, and any combination thereof.

In some examples, imidazole and its derivatives are selected from imidazole, 2-methylimidazole, 2-ethyl-4-methylimidazole, 2-undecylimidazole, 2-heptadecylimidazole, 2-phenylimidazole, 1-aminoethyl-2-methylimidazole, 1-(2-hydroxy-3-phenoxypropyl)-2-ethyl-4-methylimidazole, 1-(2-hydroxy-3-butoxypropyl)-2-methylimidazole, and 1-(2-hydroxy-3-butoxypropyl)-2-ethyl-4-methylimidazole, and any combination thereof.

In some examples, imidazoline and its derivatives are selected from 1-(2-hydroxy-3-phenoxypropyl)-2-phenylimidazoline, 1-(2-hydroxy-3-butoxypropyl)-2-methylimidazoline, 2,4-dimethylimidazoline, 2-ethylimidazoline, 2-ethyl-4-methylimidazoline, 2-benzylimidazoline, 2-phenylimidazoline, 2-(o-tolyl)-imidazoline, tetramethylene-bisimidazoline, 1,3-trimethyl-1,4-tetramethylene-bisimidazoline, 1,3,3-trimethyl-1,4-tetramethylene-bisimidazoline, 1,3-trimethyl-1,4-tetramethylene-bis-4-methylimidazoline, 1-hydroxy-3-phenoxypropyl-2-phenylimidazoline, 1-(2-hydroxy-3-butoxypropyl)-2-methylimidazoline, 1,2-phenylene-bis-imidazoline, 1,3-phenylene-bis-imidazoline, 1,4-phenylene-bis-imidazoline, 1,4-phenylene-bis-4-methylimidazoline, and any combination thereof.

The epoxy resin used for preparing the amine adduct in the core of the catalyst may be identical with or different from, preferably identical with the epoxy resin in component a) and/or the epoxy resin used for preparing the shell of the catalyst.

The epoxy resin in the shell of the catalyst is identical with or different from, preferably identical with the epoxy resin in component a), and/or the epoxy resin used for preparing the amine adduct in the core.

The definition, species and preferable species of the epoxy resin in component a) apply to the epoxy resin in the shell of the catalyst, and/or the epoxy resin used for preparing the amine adduct in the core.

There is no specific limitation on the species of polyisocyanates, and those commonly used in adhesive compositions may be used in the present disclosure.

In some examples, the polyisocyanate is a diisocyanate, a triisocyanate, or any combination thereof. In some examples, the polyisocyanate is preferably selected from the group consisting of aliphatic diisocyanates, alicyclic diisocyanates, aromatic diisocyanates, aliphatic triisocyanates, alicyclic triisocyanates, aromatic triisocyanates, and any combination thereof, and more preferably selected from aliphatic diisocyanates, alicyclic diisocyanates, aromatic diisocyanates, and any combination thereof.

In some examples, the aliphatic diisocyanate is selected from the group consisting of ethylene diisocyanate, propylene diisocyanate, butylene diisocyanate, hexamethylene diisocyanate, and trimethylhexamethylene diisocyanate, and any combination thereof.

In some examples, the alicyclic diisocyanate is selected from the group consisting of isophorone diisocyanate, 4,4′-dicyclohexylmethane diisocyanate, norbornane diisocyanate, 1,4-isocyanatocyclohexane, 1,3-bis(isocyanatomethyl)-cyclohexane, 1,3-bis(2-isocyanatopropyl-2-yl)-cyclohexane, and any combination thereof.

In some examples, the aromatic diisocyanate is selected from the group consisting of tolylene diisocyanate, 4,4′-diphenylmethane diisocyanate, xylylene diisocyanate, 1,5-naphthalene diisocyanate, and any combination thereof.

In some examples, the aliphatic triisocyanate is selected from the group consisting of 1,6,11-undecane triisocyanate, 1,8-diisocyanate-4-isocyanatomethyloctane, 1,3,6-triisocyanatomethylhexane, 2,6-diisocyanatohexanoic acid-2-isocyanatoethyl ester, 2,6-diisocyanatohexanoic acid-1-methyl-2-isocyanatoethyl ester, and any combination thereof.

In some examples, the shell of the catalyst is prepared by reacting at least two of an epoxy resin, an amine-based compound, a polyisocyanate, and optionally an amine adduct. The amine adduct in the shell of the catalyst may be identical with or different from, preferably identical with the amine adduct in the core of the catalyst. The definition and preferable technical features described above for the amine adduct in the core of the catalyst may apply to the amine adduct in the shell of the catalyst.

In some examples, the volume ratio of the core to the shell is from about 100:1 to about 100:50, preferably from about 100:1 to about 100:20. With the volume ratio of the core to the shell falling withing these ranges, the adhesive composition has a good storage stability, a good curability, and a good dispersibility.

There is no specific limitation on the ratio of the epoxy resin, the amine-based compound, the polyisocyanate, and the amine-adduct (if present) in the shell of the catalyst. Preferably, the polyisocyanate in the shell has a concentration of from about 1 to 200 meq, preferably from 10 to 100 meq per kg of the core. With the concentration of the polyisocyanate falling within the above ranges, the core-shell catalyst has a good resistance to mechanical shear force, and also imparts good curability to the whole adhesive composition.

The core-shell catalyst may have a D₅₀ particle size of from 0.5 μm to 10 μm, preferably from 1 μm to 5 μm. Herein, the “D₅₀ particle size” of the core-shell catalyst represents a median diameter in a volume-based particle size distribution curve obtained by measurement with a laser diffraction particle size analyzer.

In some examples, the core-shell catalyst is formed by dissolving the raw material of the core before, after, or simultaneously with dissolving the raw materials of the shell in a dispersion medium, then adjusting the dissolution conditions so as to make the shell deposit or coat onto the core.

Examples of commercially available core-shell catalysts include, but are not limited to, HXA series catalysts, such as HXA 4982HP and HXA 3088F, available from AsahiKASEI.

### Component d) Metal Filler

According to the present disclosure, the thermally conductive adhesive composition comprises from 50 to 98%, preferably from 60 to 95% by weight of a metal filler, based on the total weight of the thermally conductive adhesive composition.

Component d) imparts thermal conductivity as well as electrical conductivity to the whole adhesive composition.

With the content of the metal filler falling within these ranges, a good thermal conductivity and good electrical conductivity can be achieved.

In some examples, the metal filler is selected from the group consisting of silver, copper, gold, palladium, platinum, aluminum, bismuth, tin, alloy thereof, and glass coated with one or more of these metals and alloys. Preferably, the metal filler is silver.

There is no specific limitation on the shape of metal filler, and it may have various shapes such as spherical shape, granular shape, disc-like shape, columnar shape, cubic shape, rectangular parallelepiped, flake-like shape, needle-like shape, fibrous shape, and dendritic shape, with flake-like shape being preferred.

In some examples, the metal filler is silver flake which has high thermal conductivity and high electrical conductivity.

In some examples, the conductive filler may be silver flake having a D₅₀ particle size of from 0.5 to 20 μm, preferably from 0.8 to 10 μm, more preferably from 1 to 5 μm. With the D₅₀ particle size of the silver flake falling within these ranges, the silver flake imparts good thermal conductivity and electrical conductivity to the thermally conductive adhesive composition. Herein, the “D₅₀ particle size” of the silver flake represents a median diameter in a volume-based particle size distribution curve obtained by measurement with a laser diffraction particle size analyzer.

Examples of commercially available metal fillers include, but are not limited to, SA0201 available from Metalor Technologies.

### Thermally Conductive Adhesive Composition

The present invention provides a thermally conductive adhesive composition, upon intensive study, comprising:
a) from 0.5 to 30%, preferably from 2 to 20% by weight of an epoxy resin,
b) from 0.5 to 30%, preferably from 2 to 20% by weight of an anhydride,
c) from 0.1 to 5%, preferably from 0.5 to 3.5% by weight of a catalyst, and
d) from 50 to 98%, preferably from 60 to 95% by weight of a metal filler,
   based on the total weight of the thermally conductive adhesive composition,
wherein the catalyst has a core-shell structure with a shell encapsulating a core, the core of the catalyst comprises an amine-based compound, and the shell of the catalyst is prepared by reacting at least two of an epoxy resin, an amine-based compound, and a polyisocyanate.

Optionally, the thermally conductive adhesive composition further comprises additives different from components a) to d), wherein the additives are preferably selected from adhesion promoters, curing accelerators, coupling agents, solvents, colorants, plasticizers, rheological additives, and any combination thereof.

There is no specific limitation on the species and content of the optional additive(s), if present, so long as it does not adversely influence the effect of the thermally conductive adhesive composition.

In some examples, the solvent may be BCA (butyl carbitol acetate) available from Dow.

In some examples, the adhesion promotor may be A-186 or A-174 available from Momentive Performance Materials.

### Method of Producing the Thermally Conductive Adhesive Composition

The thermally conductive adhesive composition may be prepared by mixing all components together with common mixing means, such as a mortar, a propeller agitator, a kneader, a roller assembly, and a pot mill. There is no specific limitation on the charging order of each component or the mixing condition, so long as it does not adversely influence the effect of the thermally conductive adhesive composition.

In some examples, the thermally conductive adhesive composition may have a Brookfield viscosity of from 2,000 mpa·s to 100,000 mpa·s, preferably from 5,000 mpa·s to 30,000 mpa·s at 25° C., at 5 revolutions per minute (RPM), measured with Brookfield RVT viscometer and CP51 spindle.

### Use of the Thermally Conductive Adhesive Composition

The thermally conductive adhesive composition according to the present disclosure may be used in electronic devices, preferably in semiconductors and diodes, more preferably for die attach.

The thermally conductive adhesive composition may be applied onto at least a part of a surface of one adherend or both adherends, the two adherends are bonded to each other, and the two bonded adherends are then exposed to heat at a temperature of no less than 80° C. for curing.

For example, the adhesive composition according to the present disclosure may be printed or coated on a substrate by any desired method such as stencil printing, screen printing, gravure printing, or dispensing. The adhesive composition according to the present disclosure may be employed for a particular case of applying a pattern of the adhesive onto a substrate by fine-line stencil printing.

Thus, using the adhesive composition according to the present disclosure, electronic components such as semiconductor devices, chip components, diodes, discrete components or combination thereof may be joined to electrodes on a circuit board to thereby form an electronic circuit on the surface of the circuit board.

### EXAMPLES

The present disclosure is described more specifically by means of the following Examples. It should be noted that the present disclosure is by no means limited by the following description.

### Raw Materials

### Epoxy Resin

XD-1000: epoxy resin having at least two glycidyloxy group-containing aromatic groups bonded to each other by a divalent endocyclic hydrocarbon group, available from Nippon.
Epalloy™ 5200: cycloaliphatic glycidyl ester, available from CVC Specialties.
JER™ 828US: liquid bisphenol A-type epoxy resin, available from Mitsubishi Chemical.

### Anhydride

DDSA: dodecenylsuccinic anhydride, available from Milliken Chemicals.
DICY: guanidine powders, available from A & C Catalysts.
MEH-8000H: phenolic resin, available from Meiwa Plastic Industries.
Jeffamine D 2000: polyoxypropylenediamine, available from Huntsman.

### Catalyst

HXA 4982HP: core-shell catalyst, latent catalyst, D₅₀ particle size being from 1 μm to less than 10 μm, available from AsahiKASEI.
HXA 3088F: core-shell catalyst, latent catalyst, D₅₀ particle size being from 1 μm to less than 10 μm, latent hardener, available from AsahiKASEI.
EMI-24CN: ethylmethylimidazole, available from PCI Synthesis.
Fujicure FXR1081: modified aliphatic polyamines, available from T&K Toka.
PN-H: epoxy resin amine adduct, available from Ajinomoto Fine-Techno.
2MAOK: imidazole catalyst, available from Air Products.

### Metal Filler

SA0201: silver flake, available from Metalor Technologies.

### Solvent

BCA: butyl carbitol acetate, available from Dow.

### Adhesion Promoter

A-186: adhesion promotor, available from Momentive Performance Materials.
A-174: adhesion promotor, available from Momentive Performance Materials.

### Mixer Machine

For a sample size equal to or larger than 500 g, the mixer machine may be a Ross mixer. The Ross mixer may have a mixer size of from 1 L to 20 L, depending on the batch size of the sample.
For a sample size less than 500 g, the mixer machine may be a speed mixer.

### Preparation Method

In the Following Examples, the Compositions were Prepared by the Following Steps:
Component a) and solvent BCA were weighted out, mixed in a Ross mixer at 30-60 revolutions per minute (RPM) for 1 h at 80° C., and cooled down to room temperature.
component b) and component d) were weighed out, introduced into and mixed in the Ross mixer at 30-60 RPM for 15 minutes (or mixed in a speed mixer at 2000 RPM for 2 minutes) at room temperature.
Then component c) and the adhesion promoter were weighed out, introduced into and mixed in the Ross mixer at 30-60 RPM for 30 minutes (or mixed in the speed mixer at 1000 RPM for 2 minutes) at room temperature.
Subsequently, the mixture was degassed with the Ross mixer for 15 minutes (or degassed with the speed mixer for 2 minutes).

### Thermal Conductivity

Samples of the compositions obtained above were disposed in a Teflon mold having a width of 3 cm and depth (thickness) of 0.5-2 mm. The samples were cured in an oven. The temperature of the composition was then raised from 25° C. to 175° C. in 30 minutes, and kept at 175° C. for a 60 minutes period to cure the composition and thereby form thermal diffusive pellets. The thermal conductivity of said pellets was then determined via laser flash in accordance with the test method specified in ASTM E 1461. Unless specifically indicated, the raw materials in Table 1a, Table 1b and Table 2 were expressed by weight parts.

TABLE 1a

| Raw materials | | | Ex. 1 | Ex. 18 | Ex. 24 | Ex. 29 | Ex. 30 |
|---|---|---|---|---|---|---|---|
| Component a) | Epoxy resin | XD-1000 | 2.23 | 2.23 | 2.23 | | |
| | | EpalloyTM | | | | 1.41 | |
| | | 5200 | | | | | |
| | | JER ™ | | | | | 1.66 |
| | | 828US | | | | | |
| Component b) | Anhydride | DDSA | 2.1 | 2.1 | 2.1 | 2.1 | 2.1 |
| Component c) | catalyst | HXA 4982HP | 0.392 | | 0.392 | 0.392 | 0.392 |
| | | (core-shell | | | | | |
| | | catalyst) | | | | | |
| | | HXA 3088F | | 0.392 | | | |
| | | (core-shell | | | | | |
| | | catalyst) | | | | | |
| | | EMI-24CN | | | | | |
| | | Fujicure | | | | | |
| | | FXR1081 | | | | | |
| | | PN-H | | | | | |
| | | 2MAOK | | | | | |
| Component d) | Metal filler | SA0201 | 14.2 | 14.2 | 60 | 50 | 50 |
| | (Ag flake) | | | | | | |
| Optional additives | solvent | BCA | 1.12 | 1.12 | 1.72 | 1.4 | 1.15 |
| | Adhesion | A-186 | 0.112 | 0.112 | 0.112 | 0.112 | 0.112 |
| | promoter | A-174 | 0.112 | 0.112 | 0.112 | 0.112 | 0.112 |
| Total weight | | | 20.266 | 20.266 | 66.666 | 55.562 | 55.562 |
| Weight percent of Ag (wt %) | | | 70.07 | 70.07 | 90 | 90.05 | 90.05 |
| molar ratio of epoxy | | | 1.07 | 1.07 | 1.07 | 1.08 | 1.08 |
| group in component a) | | | | | | | |
| to anhydride group in | | | | | | | |
| component b) | | | | | | | |
| Thermal conductivity (w/km) | | | 2.3 | 3.7 | 31.3 | 70 | 20.2 |

TABLE 1b

| | | | CEx. | CEx. | CEx. | CEx. | CEx. | CEx. | CEx. |
|---|---|---|---|---|---|---|---|---|---|
| Raw materials | | | 2 | 10 | 19 | 20 | 21 | 36 | 37 |
| Component a) | Epoxy resin | XD-1000 | 2.23 | 2.23 | 2.23 | 2.23 | 2.23 | | |
| | | EpalloyTM | | | | | | | |
| | | 5200 | | | | | | | |
| | | JER ™ | | | | | | 1.66 | 1.66 |
| | | 828US | | | | | | | |
| Component b) | Anhydride | DDSA | 2.1 | 2.1 | 2.1 | 2.1 | 2.1 | 2.1 | 2.1 |
| Component c) | catalyst | HXA 4982HP | | | | | | | |
| | | (core-shell | | | | | | | |
| | | catalyst) | | | | | | | |
| | | HXA 3088F | | | | | | | |
| | | (core-shell | | | | | | | |
| | | catalyst) | | | | | | | |
| | | EMI-24CN | | | | 0.392 | | 0.392 | |
| | | Fujicure | | | 0.392 | | | | 0.392 |
| | | FXR1081 | | | | | | | |
| | | PN-H | | 0.392 | | | | | |
| | | 2MAOK | 0.392 | | | | | | |
| Component d) | Metal filler | SA0201 | 14.2 | 14.2 | 14.2 | 14.2 | 14.2 | 50 | 50 |
| | (Ag flake) | | | | | | | | |
| Optional | solvent | BCA | 1.12 | 1.12 | 1.12 | 1.12 | 1.12 | 1.15 | 1.15 |
| additives | Adhesion | A-186 | 0.112 | 0.112 | 0.112 | 0.112 | 0.112 | 0.112 | 0.112 |
| | promoter | A-174 | 0.112 | 0.112 | 0.112 | 0.112 | 0.112 | 0.112 | 0.112 |
| Total weight | | | 20.266 | 20.266 | 20.266 | 20.266 | 19.874 | 55.562 | 55.562 |
| Weight percent of Ag (wt %) | | | 70.07 | 70.07 | 70.07 | 70.07 | 71.45 | 90.05 | 90.05 |
| molar ratio of epoxy | | | 1.07 | 1.07 | 1.07 | 1.07 | 1.07 | 1.08 | 1.08 |
| group in component a) | | | | | | | | | |
| to anhydride group in | | | | | | | | | |
| component b) | | | | | | | | | |
| Thermal conductivity (w/km) | | | 0.5 | 0.66 | 1.2 | 0.88 | 1.2 | — | — |

TABLE 2

| | | | | CEx. | CEx. | CEx. |
|---|---|---|---|---|---|---|
| Raw materials | | | Ex. 1 | 31 | 32 | 35 |
| Component a) | Epoxy resin | XD-1000 | 2.23 | 2.23 | 2.23 | 2.23 |
| | | EpalloyTM | | | | |
| | | 5200 | | | | |
| | | JER ™ | | | | |
| | | 828US | | | | |
| Component b) | Anhydride | DDSA | 2.1 | | | |
| | Guanidine | DICY | | 0.27 | | |
| | Phenolic resin | MEH-8000H | | | 1.32 | |
| | Amine | Jeffamine D | | | | 0.6 |
| | | 2000 | | | | |
| Component c) | catalyst | HXA4982HP | 0.392 | 0.392 | 0.392 | 0.392 |
| | | (core-shell | | | | |
| | | cat.) | | | | |
| Component d) | Metal filler | SA0201 | 14.2 | 9.9 | 12.35 | 10.68 |
| | (Ag flake) | | | | | |
| Optional additives | solvent | BCA | 1.12 | 1.12 | 1.12 | 1.12 |
| | Adhesion | A-186 | 0.112 | 0.112 | 0.112 | 0.112 |
| | promoter | A-174 | 0.112 | 0.112 | 0.112 | 0.112 |
| Total weight | | | 20.266 | 14.136 | 17.636 | 15.246 |
| Weight percent of Ag (wt %) | | | 70.07 | 70.03 | 70.03 | 70.05 |
| Thermal conductivity (w/km) | | | 2.3 | 0.51 | 0.53 | 0.61 |

It can be seen from Table 1a, Table 1b and Table 2 above that in Examples 1, 18, 24, 29 and 30, the adhesive compositions according to the present disclosure achieved excellent thermal conductivity with small amounts of conductive fillers.

In Comparative Example 21, no catalyst was used. In comparative Examples 2, 10, 19, 20, 36 and 37, although a catalyst was used, it was not a core-shell catalyst. In Comparative Examples 31, 32 and 35, curing agents other than amines were used. The thermal conductivity was undesirably low or was even unmeasurable.

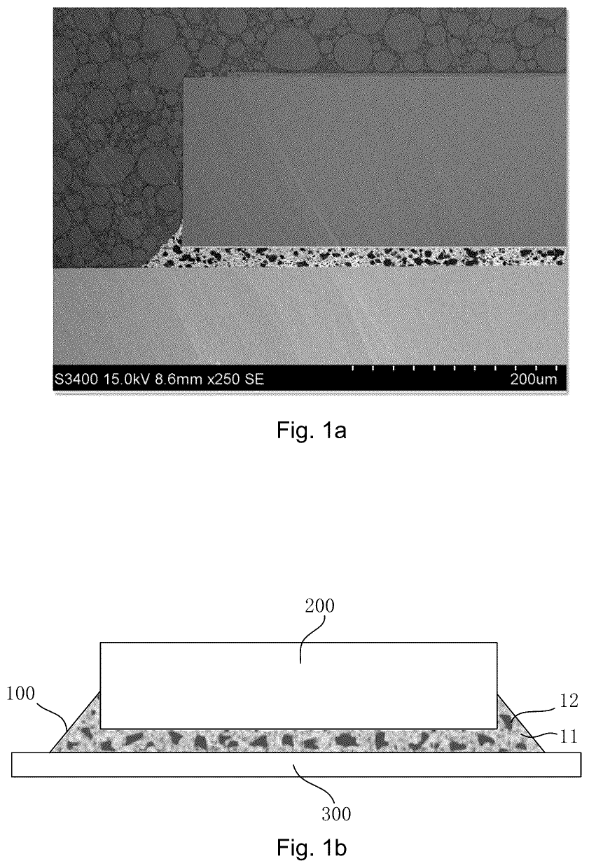

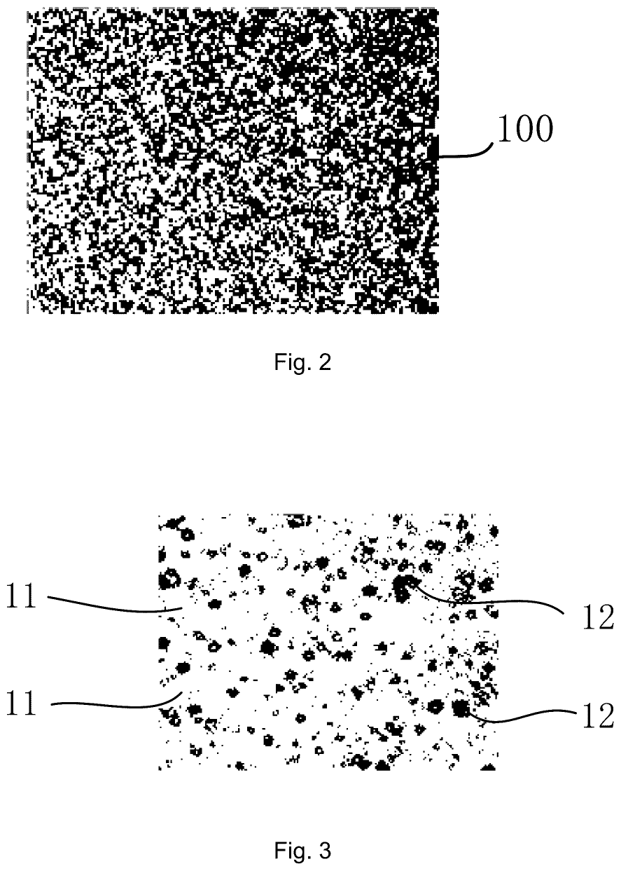

FIG. 1a is an SEM image of a cured thermally conductive adhesive composition according to Example 1 of the present invention. FIG. 1b schematically illustrates the SEM image of FIG. 1a. FIG. 2 is an optical microscope image of an uncured thermally conductive adhesive composition corresponding to FIG. 1a. FIG. 3 is an optical microscope image of a cured thermally conductive adhesive composition corresponding to FIG. 1a.

In FIG. 1a and FIG. 1b, substrate 200 and substrate 300 are bonded with a thermally conductive adhesive composition 100. In the uncured adhesive composition 100 (as shown in FIG. 2), the metal fillers and the rest of the adhesive composition (abbreviated as “resin”) are uniformly dispersed. There is neither metal-rich area nor resin-rich area. The term “metal-rich area” means the area where the metal is agglomerated, and the content of metal in this area is higher than the content of the metal in areas surrounding this area. The term “resin-rich area” means the area where the resin is agglomerated, and the content of resin in this area is higher than the content of resin in areas surrounding this area.

The present inventors surprisingly found that upon curing, the resin 12 agglomerates in the adhesive composition according to the present disclosure and drives the metal fillers 11 to become denser, as shown in FIG. 1a, FIG. 1b and FIG. 3. As a result, the metal fillers lap with each other in more areas, and the thermal conductivity of the cured adhesive composition is significantly improved. In addition, the agglomeration of the resin imparts good toughness to the cured adhesive composition and improves the stress release thereof.

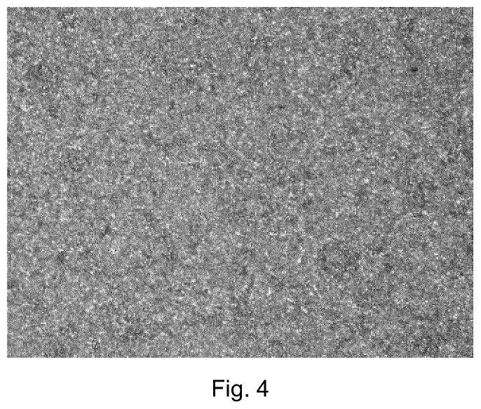

FIG. 4 is an optical microscope image of a cured thermally conductive adhesive composition according to Comparative Example 2. In FIG. 4, the metal fillers and resin are uniformly dispersed. There is neither metal-rich area nor resin-rich area.

What is claimed is:

1. A thermally conductive adhesive composition, comprising:
a) from 0.5 to 30% by weight of an epoxy resin,
b) from 0.5 to 30% by weight of an anhydride,
c) from 0.1 to 5% by weight of a catalyst, and
d) from 50 to 98% by weight of a metal filler,
based on the total weight of the thermally conductive adhesive composition,
wherein the catalyst has a core-shell structure with a shell encapsulating a core, the core of the catalyst comprises an amine-based compound, and the shell of the catalyst is prepared by reacting at least two of an epoxy resin, an amine-based compound, and a polyisocyanate.

2. The thermally conductive adhesive composition according to claim 1, wherein the epoxy resin in the shell of the catalyst is identical with or different from, preferably identical with the epoxy resin in component a),
wherein the epoxy resins in component a) and in the shell of the catalyst are independently selected from the group consisting of polyglycidyl ethers of polyphenols, polyglycidyl ethers of aliphatic polyols, polyglycidyl esters of aliphatic polycarboxylic acids, polyglycidyl esters of aromatic polycarboxylic acids, their derivatives and any combination thereof; and are preferably selected from polyglycidyl ethers of polyphenols and their hydrogenated derivatives; and more preferably selected from the group consisting of biphenol A type epoxy resins, biphenol F type epoxy resins, biphenol S type epoxy resins, hydrogenated biphenol A type epoxy resins, hydrogenated biphenol F type epoxy resins, hydrogenated biphenol S type epoxy resins, novolak type epoxy compounds, and any combination thereof.

3. The thermally conductive adhesive composition according to claim 1, wherein the anhydride in component b) is selected from monofunctional, bifunctional and multifunctional anhydrides, and is preferably selected from the group consisting of nadic anhydride (NA), methylnadic anhydride (MNA), phthalic anhydride (PA), tetrahydrophthalic anhydride (THPA), methyltetrahydrophthalic anhydride (MTHPA), hexachloroendomethylene tetrahydrophthalic anhydride (Chlorentic Anhydride), endomethylenetetrahydrophthalic anhydride, hexahydrophthalic anhydride (HHPA), methylhexahydrophthalic anhydride (MHHPA), norbonene-based anhydrides such as 5-norbonene-2,3-dicarboxylic anhydride, adipic anhydride, trimellitic anhydride, pyromellitic dianhydride, maleic anhydride (MA), succinic anhydride (SA), nonenylsuccinic anhydride, dodecenylsuccinic anhydride (DDSA), polyazelaic polyanhydride, polysebacic polyanhydride, and any combination thereof.

4. The thermally conductive adhesive composition according to claim 1, the molar ratio of epoxy group in component a) the epoxy resin to anhydride group in component b) the anhydride is from 0.2 to 3.

5. The thermally conductive adhesive composition according to claim 1, wherein the amine-based compound in the shell of the catalyst is identical with the amine-based compound in the core of the catalyst,
wherein the amine-based compounds in the core of the catalyst and in the shell of the catalyst are independently selected from the group consisting of primary amines, secondary amines, imidazole and its derivatives, imidazoline and its derivatives, and any combination thereof.

6. The thermally conductive adhesive composition according to claim 1, wherein the metal filler is selected from the group consisting of silver, copper, gold, palladium, platinum, aluminum, bismuth, tin, alloy thereof, and glass coated with one or more of these metals and alloys.

7. The thermally conductive adhesive composition according to claim 1, wherein the polyisocyanate is a diisocyanate, a triisocyanate, or any combination thereof.

8. The thermally conductive adhesive composition according to claim 1,
further comprising additives different from components a) to d), wherein the additives are selected from adhesion promoters, curing accelerators, coupling agents, solvents, colorants, plasticizers, rheological additives, and any combination thereof.

9. A method for preparing a thermally conductive adhesive composition according to claim 1 by mixing all components together.
